(19) United States
(12) Patent Application Publication
(10) Pub. No.: US 2024/0242079 A1
(43) Pub. Date: Jul. 18, 2024

(54) ARTIFICIAL INTELLIGENCE DEVICE FOR A NEURAL MODULE NETWORK AND CONTROL METHOD THEREOF

(71) Applicant: LG ELECTRONICS INC., Seoul (KR)

(72) Inventors: Homa FASHANDI, Toronto (CA); Manasa BHARADWAJ, Toronto (CA)

(73) Assignee: LG ELECTRONICS INC., Seoul (KR)

(21) Appl. No.: 18/416,640

(22) Filed: Jan. 18, 2024

Related U.S. Application Data
(60) Provisional application No. 63/439,619, filed on Jan. 18, 2023.

(51) Int. Cl. G06N 3/084

(52) U.S. Cl. CPC G06N 3/084

(57) ABSTRACT

A method for controlling an artificial intelligence (AI) device can include obtaining, via a processor in the AI device, a plurality of universal modules, receiving, via the processor in the AI device, an input image and a query related to the input image, and selecting, via the processor, a group of universal modules from among the plurality of universal modules. Also, the method can further include determining, via the processor, a layout arrangement for the group of universal modules and connecting the group of universal modules together according to the layout arrangement to form a neural module network (NMN), and outputting, via the processor, an answer based on the NMN, the query and the input image.

### CROSS-REFERENCE TO RELATED APPLICATIONS

This non-provisional application claims priority under 35 U.S.C. § 119(e) to U.S. Provisional Application No. 63/439,619, filed on Jan. 18, 2023, the entirety of which is hereby expressly incorporated by reference into the present application.

### BACKGROUND

### Field

The present disclosure relates to a device and method for a neural module network (NMN), in the field of artificial intelligence (AI). Particularly, the method can configure and train a neural module network based on curriculum learning.

### Discussion of the Related Art

Artificial intelligence (AI) continues to transform various aspects of society and helps users more efficiently retrieve information whether in the form of question and answering systems, recommendation systems, image/video captioning or visual question answering (VQA).

While AI has revolutionized various fields, its lack of explainability and transparency often hinders user trust and adoption. Explainable AI (XAI) techniques attempt to bridge this gap by providing insights into how AI systems arrive at their results.

For example, AI systems often operate as black boxes, making it difficult to understand the reasoning behind their answers. This lack of transparency can raise concerns about bias, fairness, and overall reliability. Additionally, users often desire insights into how their queries are processed and interpreted, allowing them to evaluate the validity and relevance of the provided answers. There exists a need to illuminate the inner workings of these systems, giving users a window into the logical and factual pathways that lead to each answer.

Also, developing AI solutions for complex tasks can take a considerable amount of time. Designing models, training them on vast datasets, and optimizing performance can be a lengthy process, hindering the rapid deployment of AI applications.

As AI systems become more complex, scaling them to handle large amounts of data and increasing computational demands remains a challenge. Ensuring efficiency and effectiveness as systems grow in size and complexity is a persistent concern. Also, training AI systems can be a resource intensive, time consuming and costly process.

According a need exists for a modular AI solution that is scalable, reduces design time, improves transparency and explainability, and reduces training time, which can help accelerate the adoption of AI technologies across diverse fields and help foster further advancements in AI.

### SUMMARY OF THE DISCLOSURE

The present disclosure has been made in view of the above problems and it is an object of the present disclosure to provide a device and method for a neural module network (NMN), in the field of artificial intelligence (AI). Further, the method can configure and train neural module networks (NMN).

It is another object of the present disclosure to provide a method for controlling an artificial intelligence (AI) device that includes obtaining, via a processor in the AI device, a plurality of universal modules, receiving, via the processor in the AI device, an input image and a query related to the input image, selecting, via the processor, a group of universal modules from among the plurality of universal modules, determining, via the processor, a layout arrangement for the group of universal modules and connecting the group of universal modules together according to the layout arrangement to form a neural module network (NMN), and outputting, via the processor, an answer based on the NMN, the query and the input image.

An object of the present disclosure is to provide a method for controlling an artificial intelligence (AI) device in which each of the plurality of universal modules corresponds to a single elemental sub-task.

Another object of the present disclosure is to provide a method in which the singe elemental sub-task includes one of a find task, a relocate task, an AND operation task, an OR operation task, a filter task, a count task, an exist task, a describe task, a less operation task, a more operation task, an equal operation task, and a compare task.

An object of the present disclosure is to provide a method that includes generating, via the processor, textural features or textual embeddings based on text of the query, and selecting, via the processor, the group of universal modules from among the plurality of universal modules based on the textural features or the textual embeddings.

Another object of the present disclosure is to provide a method that includes generating, via the processor, a feature map based on the input image, and determining, via the processor, the layout arrangement for the group of universal modules based on the feature map.

Yet another object of the present disclosure is to provide a method in which the plurality of universal modules includes at least two different types of visual modules configured to output a visual attention map, and at least two different types of classifier modules configured to output an answer.

Another object of the present disclosure is to provide a method in which the plurality of universal modules include a first type of visual module configured to receive visual features and textual features, and output a visual attention map, a second type of visual module configured to receive visual features, an input visual attention map and textual features, and output a visual attention map, a first type of classifier module configured to receive visual features, an input visual attention map and textual features, and output a first answer, and a second type of classifier module configured to receive visual features, a first input visual attention map, a second input visual attention map and textual features, and output a second answer.

An object of the present disclosure is to provide a method in which the group of universal modules are selected discretely or softly based on assigned weights.

Another object of the present disclosure is to provide a method that includes receiving, via the processor, a set of training samples and a number of epochs, each of the training samples including at least an image, a question and an answer, sorting, via the processor the training samples based on question length from shortest to longest to generate sorted training samples, and training the plurality of universal modules based on the sorted training samples and the number of epochs.

An object of the present disclosure is to provide a method in which each of the plurality of universal modules is a neural network model.

An object of the present disclosure is to provide an artificial intelligence (AI) device for providing recommendations that includes a memory configured to store a plurality of universal modules, and a controller configured to receive an input image and a query related to the input image, select a group of universal modules from among the plurality of universal modules, determine a layout arrangement for the group of universal modules and connect the group of universal modules together according to the layout arrangement to form a neural module network (NMN), and output an answer based on the NMN, the query and the input image.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 shows an example of components of the AI device, according to an embodiment.

FIG. 5 shows an example flow chart for a method in the AI device, according to an embodiment of the present invention.

FIG. 6 shows a question and image pair, in which each question is converted to its elemental tasks, and the module layouts are shown as examples, according to an embodiment of the present invention.

FIG. 7 shows examples of universal modules included in the module inventory, according to an embodiment of the present invention.

FIGS. 8A and 8B illustrate the internal architectures of two different types of visual models, according to embodiments.

FIGS. 9A and 9B illustrate the internal architectures of two different types of classifier models, according to embodiments.

FIG. 10 shows illustrates a curriculum learning strategy for training, according to an embodiment.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

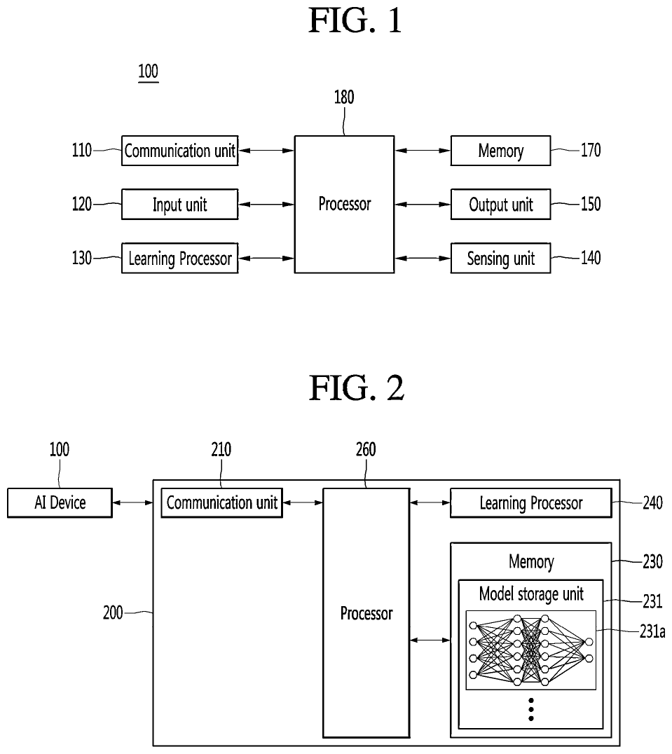

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

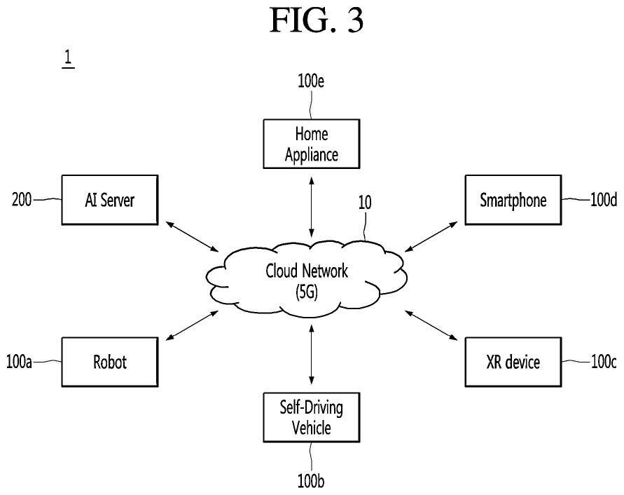

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can configure and train the neural module network (NMN), which can be used for various applications such as a question and answering system, a recommendation system, image/video captioning and visual question answering (VQA). Also, processor 180 can train the neural module network (NMN) based on curriculum learning to generate a trained NMN.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the evaluation method can be implemented as an application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100c and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

At this time, the AI server 200 can learn the artificial neural network according to the machine learning algorithm instead of the AI devices 100a to 100e, and can directly store the learning model or transmit the learning model to the AI devices 100a to 100c.

At this time, the AI server 200 can receive input data from the AI devices 100a to 100c, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement a method for a neural module network (NMN), which can be used for various applications such as a question and answering system, a recommendation system, image/video captioning and visual question answering (VQA). The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan. Also the robot 100a can be a home robot that implements the neural module network (NMN) and can answer questions from a user.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query. Also, the user query can be about objects or a scene captured by one or more cameras of the robot 100. The answer can be in the form of natural language.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can configure and train a neural module network (NMN), which can be used for various applications such as a question and answering system, a recommendations system, image/video captioning and visual question answering (VQA). Further, the AI device 100 can implement the trained NMN for carrying out commands and actions or providing various results, such as visual question answering (VQA).

The AI device 100 can obtain a knowledge graph, which can include a web of interconnected facts and entities (e.g., a web of knowledge). A knowledge graph is a structured way to store and represent information, capturing relationships between entities and concepts in a way that machines can understand and reason with.

According to an embodiment, the AI device 100 can include one or more knowledge graphs that include entities and properties or information about people or items (e.g., names, user IDs), products (e.g., display devices, home appliances, etc.), profile information (e.g., age, gender, weight, location, etc.), recipe categories, ingredients, images, purchases and reviews.

According to an embodiment, a knowledge graph can capture real world knowledge in the form of a graph structure modeled as (h, r, t) triplets where h and t refer to a head entity and a tail entity respectively, and r is a relationship that connects the two entities.

Also, knowledge graph completion can refer to a process of filling in missing information in a knowledge graph, making it more comprehensive and accurate (e.g., similar to piecing together a puzzle, uncovering hidden connections and expanding the knowledge base). Link prediction can identify missing links in a knowledge graph (KG) and assist with downstream tasks such as question answering and recommendation systems.

According to another embodiment, the AI device 100 can be integrated into an infotainment system of the self-driving vehicle 100b, which can recommend content or provide answers based on various input modalities including images or video. Also, the content can include one or more of audio recordings, video, music, pod casts, etc., but embodiments are not limited thereto. Also, the AI device 100 can be integrated into an infotainment system of the manual or human-driving vehicle.

Some tasks are compositional, meaning they are complex tasks built up from simpler tasks (e.g., sub-tasks). For instance, for the complex task of visual question answering (VQA), sub-tasks can be object detection, object classification, attribute classification, counting, relationship detection, etc. For visual question answering (VQA), the composition of the sub-tasks can be obtained by the available textual information (e.g., the question in the VQA).

According to an embodiment, the AI device 100 can implement a complex task as a decomposition of simpler ones using Neural Module Networks (NMN).

For example, there can be n elemental tasks, T₁, T₂, . . . , Tₙ. The elemental tasks are not decomposable into simpler tasks but are composable and independent. The composite tasks, Cᵢs, can be produced by linking together some elemental tasks, [Tᵢ₁, Tᵢ₂, . . . , Tᵢₖ]. The solution for an elemental sub-task may not be context-free. For example, the composite solution can be sensitive to the order in which the elemental tasks are called or arranged. Also, each task can be referred to as a model.

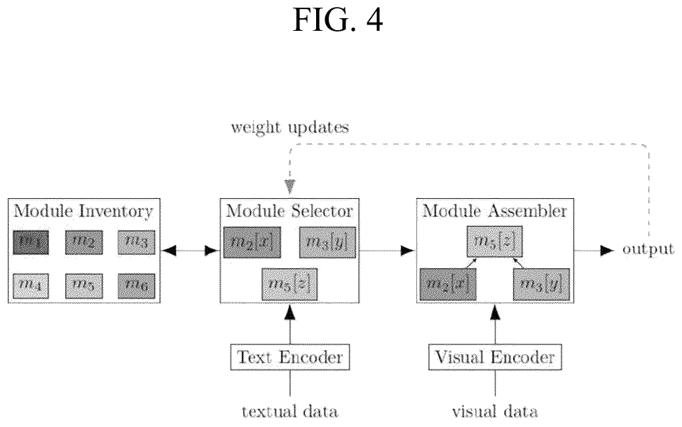

FIG. 4 shows an example of components of the AI device 100, according to an embodiment. For example, the AI device 100 can include a module inventory, a module selector, and a module assembler. The module inventory holds predefined element tasks, e.g., modules. The module selector selects a set of modules from the module inventory, and the module assembler builds the composite solution. Input information can be in the form of training samples and/or external knowledge.

Also, each module in the module inventory can be a small neural network that implements an elemental task, e.g., FIND(object). The module selector can select the appropriate modules to decompose the composite task. The module selector can linguistic information (e.g., from the question), if applicable, to choose the modules and the parameters of the modules. The module selector can be a neural network or a rule-based system. The module assembler then assembles the selected modules into a valid layout or composition.

In other words, all the smaller neural networks can be connected together in a meaningfully way to build the neural module network (NMN). The visual and linguistic information is the input to this assembled neural module network.

According to an embodiment, the AI device 100 can iteratively repeat this process for the upcoming training samples, each of which can have a different composite architecture. During the inference time, a neural network tailored to the sample, possibly unobserved during training, can be built for each sample.

For instance, the module inventory can define a type of search space that includes composable and dependent neural modules (e.g., neural models) for the elemental tasks. According to an embodiment, the modules can be hand engineered for each sub-task.

However, according to a preferred embodiment, the modules can be universal modules that are not hand engineered for a specific sub-task. Rather, the universal modules can learn based on their location within an arrangement or layout put together by the module assembler. The universal modules can also be referred to as generic modules, meaning that they are not hand engineered for a specific sub-task.

In other words, the universal modules can be viewed as being analogous to the convolution layer in a convolutional neural network (CNN), in which a convolution layer learns different filters based on its placement within the CNN. Similarly, the universal modules can learn their specific tasks based on their placement location within the NMN as arranged by the module assembler.

In addition, the universal modules' architectures are not specialized to the sub-task. In this way, instead of having a possibility unique architecture, which can be time consuming to design, the architecture is selected from the universal modules architecture. The universal modules can decrease the design time and improve the NMN's scalability to a new problem domain.

Also, the universal modules can provide transparency and explainability of how a complex task has been solved because they are decomposing a complex task into a series of simpler tasks. For example, the explainability of the NMN is due, at least in part, to the output of the universal modules which produce either an answer or a visual attention map. Therefore, this allows validation of the intermediate outputs, in contrast to outputting features maps which are not easily interpretable.

Also, the modules in the NMN can carry symbolic meaning. In other words, the composed architecture can convey a meaning influenced by the input information (e.g., textual information). The module selector in the NMN can implement search strategies for selecting modules that includes one or more of evolutionary algorithms, reinforcement learning (RL), and gradient-based techniques, but embodiments are not limited thereto.

The AI device 100 with the NMN can implement a search strategy that searches for an optimal architecture for each sample. Also, the modules continuously learn to perform the assigned task during the training.

Also, each of the universal modules can be a small or shallow neural network. Also, each of the module selector and the module assembler can be a neural network, but embodiments are not limited thereto. For example, one or more of the module selector and the module assembler can be a rules-based system.

According to embodiments, the module selector can implement discrete selection of the modules or soft selection of the modules.

Regarding discrete selection, the module selector can perform the discrete sampling of the modules and form a tree structure of the selected modules to predict the answer. Therefore, the sampling phase is discrete and non-differentiable and may not be trained with full backpropagation. According to an embodiment, the loss can be formulated according to Equation 1 below.

$$L ( θ ) = \text{?} [ \hat{L} ( θ , l ; q , I ) ] \qquad ( 1 )$$

$$\text{?} \text{indicates text missing or illegible when filed}$$

The \hat{L} is the softmax loss over the output answers. Also, for the non-differentiable parts of the loss, RL's policy gradient method can be used. The backpropagation can be utilized for the differentiable part of the loss. According to an embodiment, the gradient of loss can be estimated with Monte-Carlo sampling according to Equation 2 below.

$$\text{?} L \approx \frac{1}{M} {\sum }_{m = 1}^{M} ( \hat{L} ( θ , {l}_{m} ) \text{?} log p ( {l}_{m} \vert q ; θ ) + \text{?} \hat{L} ( θ , {l}_{m} ) ) \qquad ( 2 )$$

$$\text{?} \text{indicates text missing or illegible when filed}$$

Regarding soft selection, the module selector can use weights to select the modules. For example, at each time step t, the module selector can assign continuous weights to the modules and determine their textual parameter. The output of the neural module network at time t is the weighted average of the modules' outputs. To keep track of the intermediate outputs at time t, which are the inputs to the modules at time t′>t, a differentiable memory stack can be used by the AI device 100.

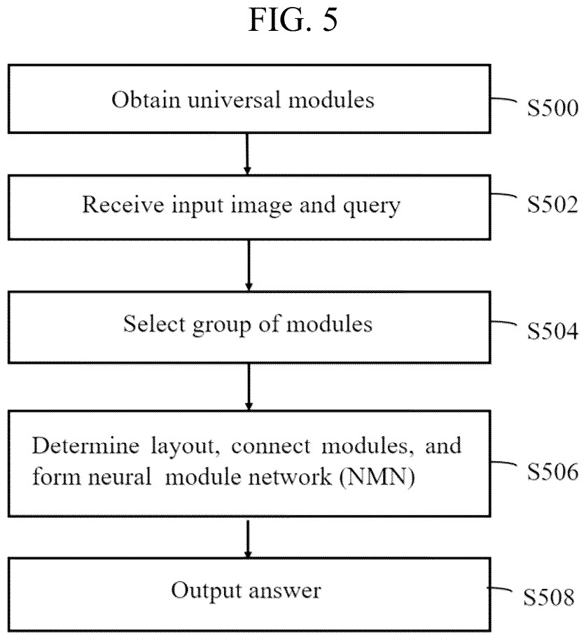

FIG. 5 shows an example flow chart of a method according to an embodiment. For example, the AI device 100 can be configured with a method for controlling an artificial intelligence (AI) device that includes obtaining, via a processor in the AI device, a plurality of universal modules (S500), receiving, via the processor in the AI device, an input image and a query related to the input image (S502), and selecting, via the processor, a group of universal modules from among the plurality of universal modules (S504). Also, the method can further include determining, via the processor, a layout arrangement for the group of universal modules and connecting the group of universal modules together according to the layout arrangement to form a neural module network (NMN) (S506), and outputting, via the processor, an answer based on the NMN, the query and the input image (S508).

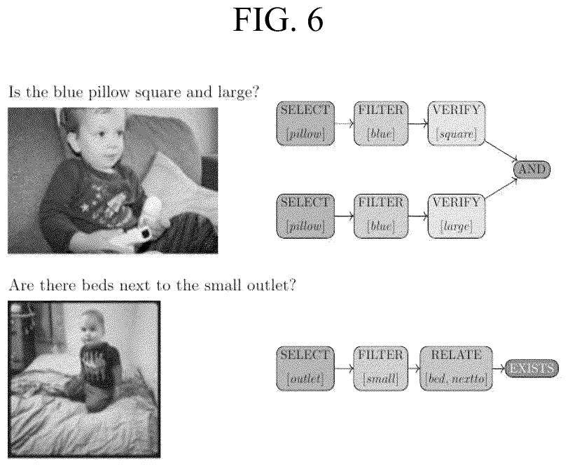

FIG. 6 shows a question and image pair, in which each question is converted to its elemental tasks, and the module layouts are shown as examples. Also, the example question and image pairs are from the GQA dataset from Stanford, but these are merely examples and different types of questions and images can be used.

For example, in visual question answering (VQA), the AI device 100 can receive a question-image pair (e.g., “Is the blue pillow square and large?” and the image of the child on the sofa). The AI device 100 implementing the NMN can first convert the question into its elemental tasks and build a module layout by connecting the modules meaningfully. Each elemental task, e.g., module, can be modeled with a neural network. For example, the modules can include a select module, a filter module, a verify module, an “and” module, a relate module, and an exists module, etc.

With reference to FIG. 4 again, the AI device 100 can further include a text encoder connected to the module selector and a visual encoder connected to the module assembler. The user query (e.g., question) is input to the text encode to generate textual embeddings or textual features which are input to the module selector.

Using the output of the text encoder, the module selector can determine a subset of modules to select from the module inventory to generate a list of modules. The list of modules is input to the module assembler.

Also, the visual encoder connected to the module assembler can receive an input image (e.g., the image of the child on the sofa) and can generate a feature map based on the input image. According to an embodiment, the visual encoder can be convolutional neural network (CNN) based.

The module assembler receives the feature map from the visual encoder and the list of modules from the module selector, and determines a layout arrangement for the modules and connects them together. Then, the connected arrangement of modules forms a specific NMN for answering the question and outputs the answer. Also, this process can be repeated for upcoming training samples, each of which can have a different composite architecture.

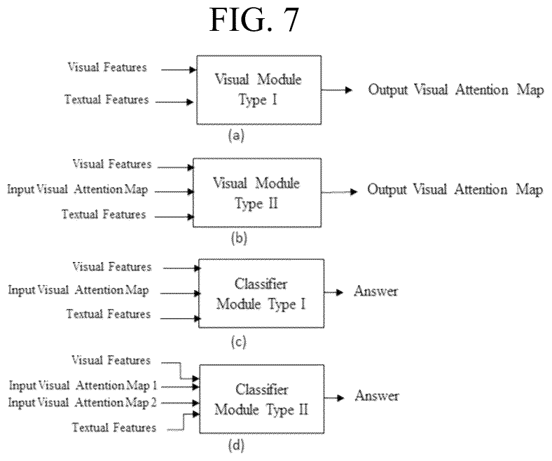

FIG. 7 shows examples of universal modules that can be included in the module inventory. According to an embodiment, the module inventory can include four different types of modules that include at least two different types of visual modules and at least two different types of classifier modules. For example, the AI device 100 implementing the NMN can avoid having to rely on a single classifier which would have to perform different tasks.

FIG. 7 illustrates the inputs and outputs of the universal modules. Visual features can be obtained by processing the input image by a convolutional neural network (CNN) and selecting the appropriate feature maps.

Also, the textual features can be obtained by processing the textual information of the input question. The input visual attention map is the output of the previous module connected to the current module in the module layouts.

In addition, the input visual attention maps can highlight the areas of the input image that should be important for or focused on by the current module. For example, the output visual attention map shows which areas of the input image resulted from applying the current module.

Also, the visual attention map can be a type of heat map. When a model processes an image, the visual attention map highlights the areas it “looked at” most attentively to understand the content. This information can be displayed as a heat map overlaid on the image, with brighter areas representing higher attention focus and darker areas representing lower focus.

For example, for the FIND module with the input parameter of apple, the output visual attention map highlights the image regions that resemble apples. The answer is the final answer to the question, and the classifier modules are the types of modules used to produce the answers.

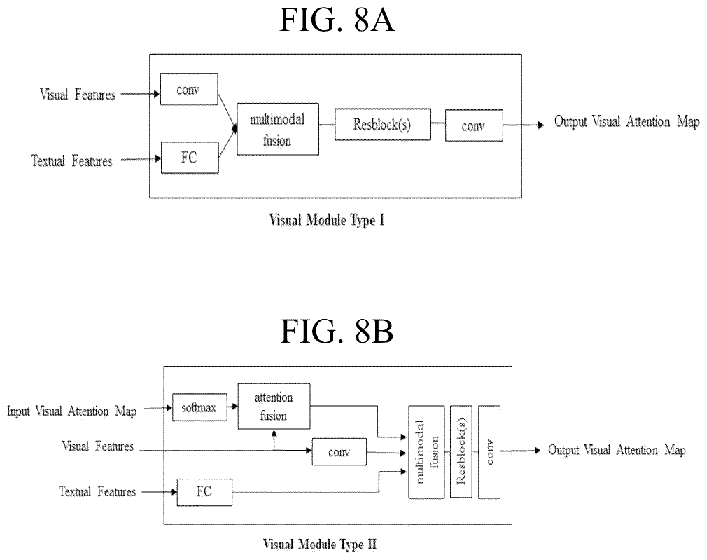

FIG. 8A illustrates the internal architecture of the visual module type I, according to an embodiment. The multimodal fusion block receives the processed visual features from a convolution layer and the processed textual features from a fully connected layer. The multimodal fusion can fuse these two types of information. The process could be implemented by a dot product of two inputs and pass through a normalization layer, but embodiments are not limited there to and other implementations are also possible. The fused features go through one or more Resblocks and pass through a convolution layer to produce the output visual attention map.

For example, a fully connected layer (which can also be referred to as a dense layer) can include neurons in which every single neuron is connected to every single neuron in the previous layer. Also, the fully connected layer can have weights and biases in which each connection between neurons can have an associated weight, which represents the strength of the connection. Additionally, each neuron in the fully connected layer can have a bias. The output of a neuron can be the sum of the products of its inputs and their corresponding weights, plus the bias.

Also, the fully connected layer can have an activation function in which after computing the weighted sum and adding the bias, the result can through an activation function, introducing non-linearity to the network.

FIG. 8B illustrates the internal architecture of the visual module type II, according to an embodiment. The attention fusion block can be applied with the processed (application of softmax) to the input visual features. An example of such a module can be a dot product followed by a normalization layer. However, embodiments are not limited thereto and the fusion could be implemented in other ways.

The multimodal fusion block can receive the attended visual and textual features and fuse them. This can include the dot product of the input feature maps. The resulting feature maps can go through one or more Resblocks and finally pass through a convolution layer to produce the output visual attention map.

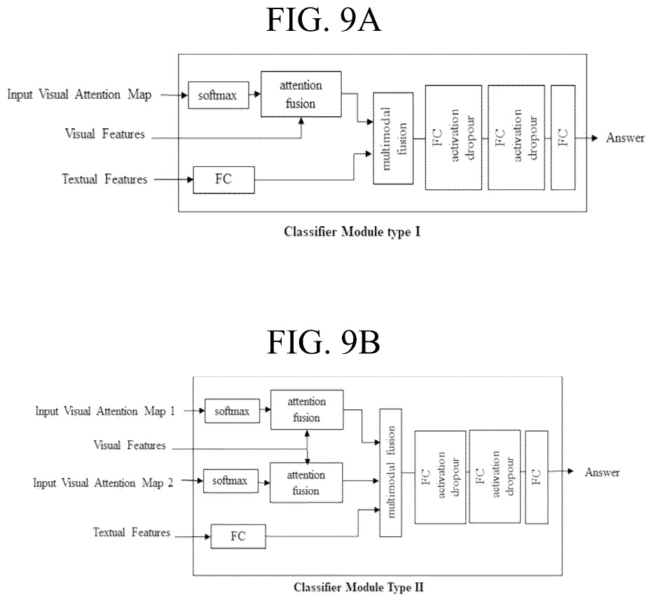

FIG. 9A shows the internal architecture of classifier module type I, according to an embodiment. The attention fusion module can fuse the visual features and the visual attention map processed with the softmax layer. This block can include a dot product of the two feature maps and the normalization layer.

Then, the multimodal fusion block can receive the original visual features, the attended visual features, and the textual features and fuse them. This can include the dot product of the input feature maps. The resulting feature maps can go through a series of fully connected layers, activation layers and dropout layers. The final fully connected layer can produce the answer.

FIG. 9B illustrates the internal architecture of the classifier module type II, according to an embodiment. This module can receive two input visual attention maps (e.g., Map 1 and Map 2). The visual features are fused in two fusion blocks with these two input attention maps. These blocks can include a dot product followed by a normalization layer, but embodiments are not limited thereto.

In addition, the attention-fused feature maps, along with processed textual features which passed through a fully connected layer, pass through a multimodal fusion block. This block can include the dot product of its input, but embodiments are not limited thereto. The resulting output can pass through a series of fully connected layers, followed by an activation and dropout layer. The final fully connected layer can produce the answer.

For example, while the two different types of visual modules may have different types inputs and a different number of inputs, both of the visual module type I and visual module type II output a visual attention map.

According to an embodiment, the visual attention map can include a type of heat map. For example, visual attention map can indicate which visual features or which parts of an image are to be focused on by a module.

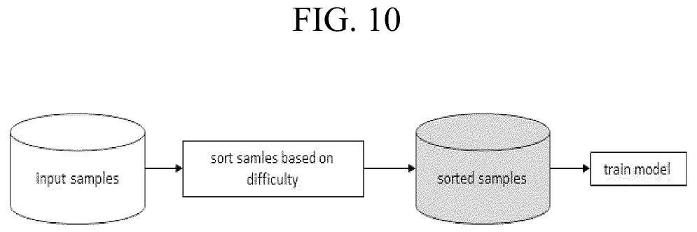

FIG. 10 illustrates a curriculum learning strategy for training, according to an embodiment.

Training the neural module network (NMN) can be challenging, as each sample may have a different network structure. For example, the modules are not trained consistently as their call rate by the module selector may not uniform, and some weights are updated much more frequently than others.

Based on the layout, the modules consume the output of other modules. Therefore, they rely on the other modules' performances during the training. Generally, there may be only two training signals: the composite task training signal (e.g., for the VQA, the answer to the question). This signal is always available. The other training signal, which may or may not be available, is the ground truth layout signal, which helps the module selector to perform better.

However, whether there are two training signals available or only the one training signal, the modules need to learn how to perform a specific task based on their placement in the architecture and the input they receive from the input layer or the other modules.

Further, the modules do not necessarily receive their sub-task-specific training signal, which can make the training process challenging. This issue can be more significate in the universal modules with the open designs as there is no strong design bias in the tasks they are supposed to perform. Moreover, the call rate of the modules is not consistent. Therefore, not all the modules have the same training time, which adds to the training challenges.

In order to address these issues, a specific type of learning curriculum can be used to improve and speed up the training process. According to an embodiment, a module's difficulty can be defined based on the length of the question. For example, shorter questions often require fewer modules to predict the answer. Therefore, a few modules will be called more often at the beginning of training, providing better input for the other modules.

As shown in FIG. 10, the AI device 100 can sort the training samples based on their difficulty (e.g., according to the length of the question) and then feed the sorted samples to the training model.

The definition of the difficulty of the samples (e.g., difficulty measure) is the main decision in this strategy. For this particular application, visual question answering, and its neural module implementation, the sample difficulty can be defined based on the question length or the length of the ground truth module layout, if available.

According to an embodiment, the training can include a set of T training samples, where T={(image, question, module layout (optional), answer)}, and can involve a number of epochs. Also, if curriculum learning is activated, the training samples can be sorted based on the question lengths (e.g., shorter questions at the beginning, and longer questions towards the end).

For example, a training loop can include: for each epoch in range (1, number_of_epochs): for each training sample of type (image, question, module layout (optional), answer) in T: 1) the module Selector receives the linguistic information (e.g., the question) and outputs either the name of the required sub-tasks (modules) if module selector is discrete or importance weight of each module if module selector is soft and each module's textual input arguments, 2) the module assembler receives the output of the module selector, 3) if the module selector is discrete: the layout can be in reverse Polish format and the module assembler builds the neural module network by assembling the modules into a tree format, 4) if the module selector is not-discrete (e.g., soft selection of the modules), each module receives importance weights, 5) each module receives their textual input argument and visual features, 6) the neural module network processes the input image and input question; if applicable, throughout this step each module receives required visual attention maps calculated from relevant modules depending on their placement in the layout, 7) the neural module network calculates the loss based on comparing the answer and predicted answer, 8) if the module selector is a neural network and not frozen and module layout is available, the layout loss is calculated and added to the loss calculated in step 7) and the weight of the module selector are adjusted, and 9) the neural module network's weights are adjusted based on the calculated loss.

In other words, the group of visual modules can be used to tackle tough visual questions. Each training session, the selected visual modules can analyze images and answer queries, refining their skills through a feedback loop. The module selector picks the right visual modes for the current task or training sample, while the module assembler organizes their arrangement or layout configuration. The selected visual models share insights, analyze details, and strive for accurate answers. If mistakes or errors are made, adjustments are implemented, allowing the visual modules to become shaper and more improved with each practice round. Through this collaborative learning process, the visual models can better understand and respond to questions about visual images.

In addition, since the group of visual modules first begin their training based on short questions and then progressively move on to longer and longer questions, the group of visual modules can learn faster and training time can be reduced. For example, the length of the question can be used as a proxy for difficultly (e.g., training on easy questions in the beginning and then moving onto harder questions).

According to an embodiment, the AI device 100 can be configured with the NMN can implement a visual question-answering application. The AI device 100 can be used in various applications, such as a home robot or personal assistant. Also, the AI device 100 can answer a user's question about an image or scene.

For example, a user can ask the AI device 100, “how many apples do I have on the table?” In this situation, the AI device 100 needs to find the table, then find the apples on the table and count the apples to answer the user. One of the benefits of using the NMN approach, as detailed above, is that the AI device 100 can explain to the customer how it achieved such an answer.

According to an embodiment, the AI device 100 can be configured to answer user queries and/or recommend items (e.g., home appliance devices, mobile electronic devices, movies, content, advertisements or display devices, etc.), options or routes to a user. The AI device 100 can be used in various types of different situations.

According to one or more embodiments of the present disclosure, the AI device 100 can solve one or more technological problems in the existing technology, such as visual question answering (VQA) or image/video captioning.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, a plurality of universal modules;
receiving, via the processor in the AI device, an input image and a query related to the input image;
selecting, via the processor, a group of universal modules from among the plurality of universal modules;
determining, via the processor, a layout arrangement for the group of universal modules and connecting the group of universal modules together according to the layout arrangement to form a neural module network (NMN); and
outputting, via the processor, an answer based on the NMN, the query and the input image.

2. The method of claim 1, wherein each of the plurality of universal modules corresponds to a single elemental sub-task.

3. The method of claim 2, wherein the singe elemental sub-task includes one of a find task, a relocate task, an AND operation task, an OR operation task, a filter task, a count task, an exist task, a describe task, a less operation task, a more operation task, an equal operation task, and a compare task.

4. The method of claim 1, further comprising:
generating, via the processor, textural features or textual embeddings based on text of the query; and
selecting, via the processor, the group of universal modules from among the plurality of universal modules based on the textural features or the textual embeddings.

5. The method of claim 1, further comprising:
generating, via the processor, a feature map based on the input image; and
determining, via the processor, the layout arrangement for the group of universal modules based on the feature map.

6. The method of claim 1, wherein the plurality of universal modules includes at least two different types of visual modules configured to output a visual attention map, and at least two different types of classifier modules configured to output an answer.

7. The method of claim 6, wherein the plurality of universal modules include:
a first type of visual module configured to receive visual features and textual features, and output a visual attention map,
a second type of visual module configured to receive visual features, an input visual attention map and textual features, and output a visual attention map,
a first type of classifier module configured to receive visual features, an input visual attention map and textual features, and output a first answer, and
a second type of classifier module configured to receive visual features, a first input visual attention map, a second input visual attention map and textual features, and output a second answer.

8. The method of claim 1, wherein the group of universal modules are selected discretely or softly based on assigned weights.

9. The method of claim 1, further comprising:
receiving, via the processor, a set of training samples and a number of epochs, each of the training samples including at least an image, a question and an answer;
sorting, via the processor the training samples based on question length from shortest to longest to generate sorted training samples; and
training the plurality of universal modules based on the sorted training samples and the number of epochs.

10. The method of claim 1, wherein each of the plurality of universal modules is a neural network model.

11. An artificial intelligence (AI) device, the AI device comprising:
a memory configured to store a plurality of universal modules; and
a controller configured to:
receive an input image and a query related to the input image,
select a group of universal modules from among the plurality of universal modules,
determine a layout arrangement for the group of universal modules and connect the group of universal modules together according to the layout arrangement to form a neural module network (NMN), and
output an answer based on the NMN, the query and the input image.

12. The AI device of claim 11, wherein each of the plurality of universal modules corresponds to a single elemental sub-task.

13. The AI device of claim 12, wherein the singe elemental sub-task includes one of a find task, a relocate task, an AND operation task, an OR operation task, a filter task, a count task, an exist task, a describe task, a less operation task, a more operation task, an equal operation task, and a compare task.

14. The AI device of claim 11, wherein the controller is further configured to:
generate textural features or textual embeddings based on text of the query, and
select the group of universal modules from among the plurality of universal modules based on the textural features or the textual embeddings.

15. The AI device of claim 11, wherein the controller is further configured to:
generate a feature map based on the input image, and
determine the layout arrangement for the group of universal modules based on the feature map.

16. The AI device of claim 11, wherein the plurality of universal modules includes at least two different types of visual modules configured to output a visual attention map, and at least two different types of classifier modules configured to output an answer.

17. The AI device of claim 16, wherein the plurality of universal modules include:
a first type of visual module configured to receive visual features and textual features, and output a visual attention map,
a second type of visual module configured to receive visual features, an input visual attention map and textual features, and output a visual attention map,
a first type of classifier module configured to receive visual features, an input visual attention map and textual features, and output a first answer, and
a second type of classifier module configured to receive visual features, a first input visual attention map, a second input visual attention map and textual features, and output a second answer.

18. The AI device of claim 11, wherein the group of universal modules are selected discretely or softly based on assigned weights.

19. The AI device of claim 11, wherein the controller is further configured to:
obtain a set of training samples and a number of epochs, each of the training samples including at least an image, a question and an answer,
sort the training samples based on question length from shortest to longest to generate sorted training samples, and
train the plurality of universal modules based on the sorted training samples and the number of epochs.

20. The AI device of claim 11, wherein each of the plurality of universal modules is a neural network model.
